(19) United States
(12) Patent Application Publication
(10) Pub. No.: US 2014/0095401 A1
(43) Pub. Date: Apr. 3, 2014

(54) System and Method of Evaluating Candidates for a Hiring Decision

(71) Applicant: HIREIQ SOLUTIONS, INC., Alpharetta, GA (US)

(72) Inventors: Todd Merrill, Alpharetta, GA (US); Ben Olive, Atlanta, GA (US); Kevin Hegebarth, Johns Creek, GA (US); Corey Mayo, Dawsonville, GA (US); Robert Morris, Acworth, GA (US)

(73) Assignee: HIREIQ SOLUTIONS, INC., Alpharetta, GA (US)

(21) Appl. No.: 14/039,629

(22) Filed: Sep. 27, 2013

Related U.S. Application Data
(60) Provisional application No. 61/707,316, filed on Sep. 28, 2012.

(51) Int. Cl. G06Q 10/10

(52) U.S. Cl. CPC G06Q 10/1053
USPC 705/321

(57) ABSTRACT

The system and method of the present application utilizes a number of analysis modules to apply analysis techniques to candidate applications. The analysis modules then apply a score for each candidate for each technique with feedback information into an aggregate score. The system and method of the present application controls the collection order of the scores can weight scores by technique, and provide a graphical user interface for ease of evaluation.

### CROSS-REFERENCE TO RELATED APPLICATIONS

This application claims priority to U.S. Provisional Application No. 61/707,316, filed Sep. 28, 2012, the content of which is incorporated herein by reference in its entirety.

### FIELD

The present application relates to the field of candidate evaluation. More specifically, the present application relates to the field of candidate evaluation based on analysis techniques and feedback.

### BACKGROUND

Organizations that hire many people need to screen large volumes of applicants. The process of screening applicants is currently a combination of written or on-line assessments and usually a manually intensive interaction with the candidates through phone or in-person interviews. Automating the screening process yields cost savings by minimizing recruiter time spent on screening applications, and improving the quality of applicants. This ultimately reduces turnover, investment in recruitment costs, and can improve the quality of candidate hired. However, currently systems do not utilize candidate evaluation based on analysis techniques and feedback.

### SUMMARY

The system and method of the present application utilizes a number of analysis modules to apply analysis techniques to candidate applications. The analysis modules then apply a score for each candidate for each technique with feedback information into an aggregate score. The system and method of the present application controls the collection order of the scores can weight scores by technique, and provide a graphical user interface for ease of evaluation.

The system and method of the present application also allows third-party assessment techniques to be administered through a pluggable module and third-party communication with the controller through an event sink and event emitter, through a position module.

In one aspect of the present application, a computerized method, comprises receiving a plurality of candidate applications into a valuation system, applying a plurality of analysis techniques to each of the plurality of candidate applications, assigning a score for each of the plurality of analysis techniques corresponding to each of the plurality of candidate applications, combining the scores of the plurality of analysis techniques for each of the plurality of candidate applications with a set of feedback information for each of the plurality of candidate applications, and outputting an aggregate score based on the combining.

In another aspect of the present application, a non-transitory computer-readable medium having computer executable instructions for performing a method, comprises receiving a plurality of candidate applications into a valuation system, applying a plurality of analysis techniques to each of the plurality of candidate applications, assigning a score for each of the plurality of analysis techniques corresponding to each of the plurality of candidate applications, combining the scores of the plurality of analysis techniques for each of the plurality of candidate applications with a set of feedback information for each of the plurality of candidate applications, and outputting an aggregate score based on the combining.

In another aspect of the present application, in a computer system having a graphical user interface, a method of providing an aggregate score for each of a plurality of candidates for a position, the method comprises applying a plurality of analysis techniques to each of a plurality of candidate applications, assigning a score for each of the plurality of analysis techniques and combining the scores to derive the aggregate score for each of the plurality of candidates, displaying on the graphical user interface, a list of the plurality of candidates, a listing of a plurality of score icons corresponding to the list of the plurality of candidates, and a list of a plurality of URLs corresponding to the list of the plurality of candidates, where the list of the plurality of candidates provides additional information for each of the plurality of candidates.

### BRIEF DESCRIPTION OF THE DRAWINGS

FIG. 1 is a schematic diagram illustrating an embodiment of the system of the present application.

FIG. 2 is flow diagram illustrating an embodiment of the system of the present application.

FIG. 3 is a graphical representation of an embodiment of a graphical user interface of the present application.

FIG. 4 is a schematic diagram illustrating an embodiment of the system of the present application.

FIG. 5 is a flow diagram illustrating an embodiment of the system of the present application.

FIG. 6 is a flow diagram illustrating an embodiment of the method of the present application.

FIG. 7 is a system diagram of an exemplary embodiment of a system for automated model adaptation.

### DETAILED DESCRIPTION OF THE DRAWINGS

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

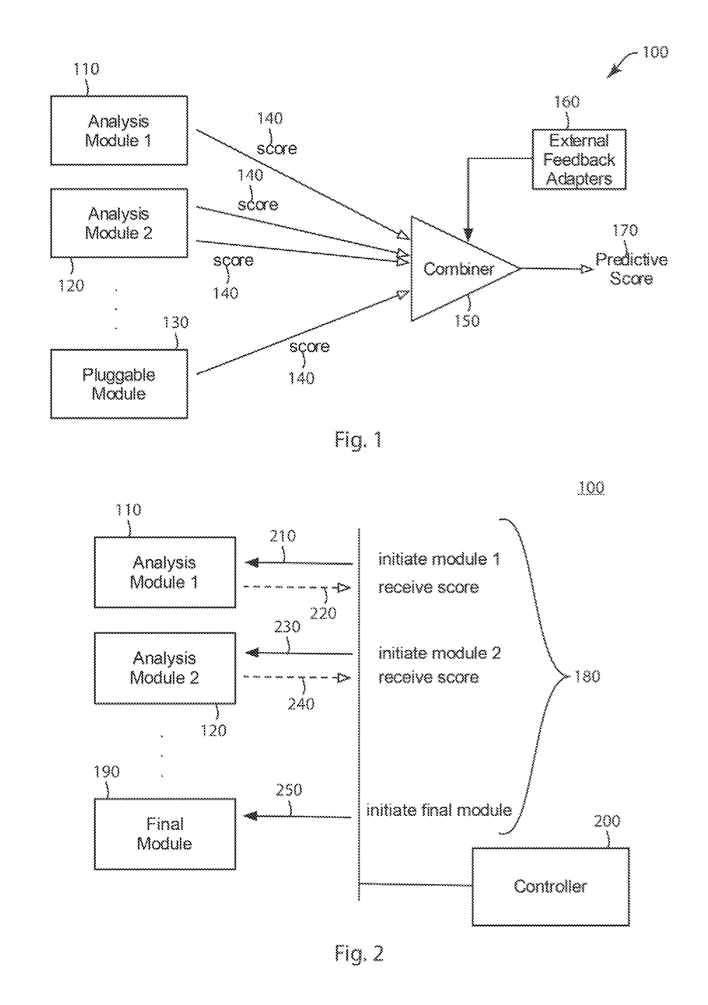

Disclosed herein are various embodiments of systems and methods of automating a hiring decision through the administration of one or more automated or manual assessments. An exemplary method is proposed to combine one or more assessments into a relative ranking for a candidate among his peers applying for as given position. FIG. 1 illustrates the relationships of major components of the system 100.

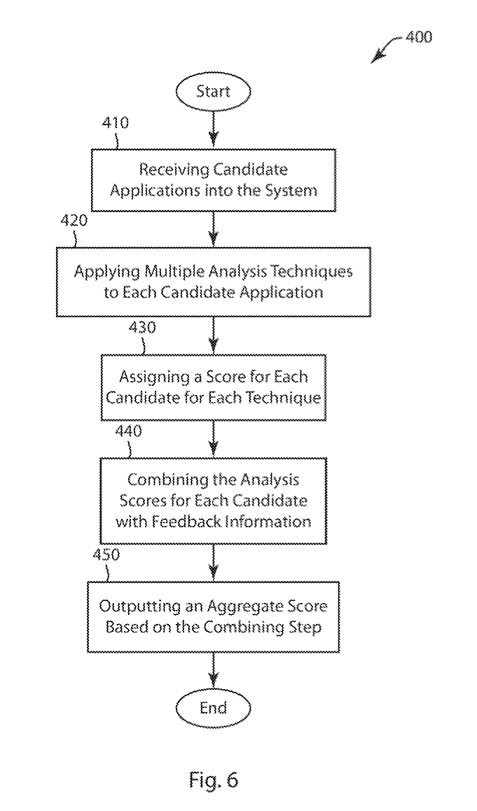

The system 100 and method 400 (FIG. 6) of the present application may be effectuated and utilized with any of a variety of computers or other communicative devices, exemplarily, but not limited to, desk top computers, laptop computers, tablet computers, or smart phones. The system will also include, and the method will be effectuated by a central processing unit that executes computer readable code such as to function in the manner as disclosed herein. Exemplarily, a graphical display that visually presents data as disclosed herein by the presentation of one or more graphical user interfaces (GUI) is present in the system. The system further exemplarily includes a user input device, such as, but not limited to, a keyboard, mouse, or touch screen that facilitate the entry of data as disclosed herein by a user. Operation of any part of the system and method may be effectuated across a network or over a dedicated communication service, such as land line, wireless telecommunications, or LAN/WAN.

The system further includes a server that provides accessible web pages by permitting access to computer readable code stored on a non-transient computer readable medium associated with the server, and the system executes the computer readable code to present the GUIs of the web pages.

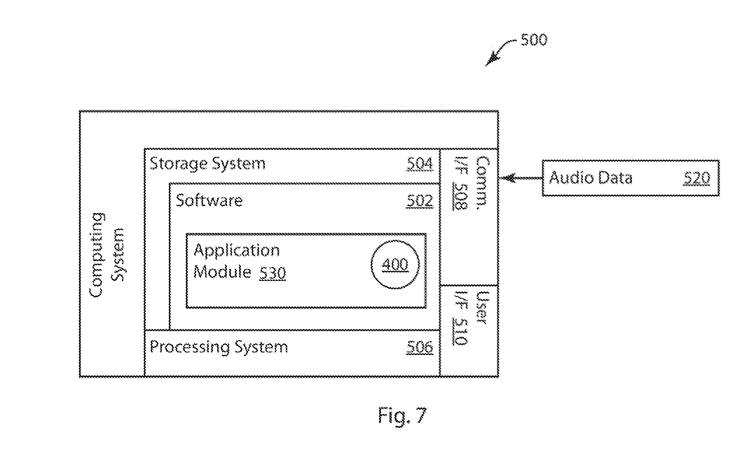

FIG. 6 is a flow diagram that depicts an exemplary embodiment of a method 400 of candidate evaluation. FIG. 7 is a system diagram of an exemplary embodiment of a system 500 for candidate evaluation. The system 500 is generally a computing system that includes a processing system 506, storage system 504, software 502, communication interface 508 and a user interface 510. The processing system 506 loads and executes software 502 from the storage system 504, including a software module 530. When executed by the computing system 500, software module 530 directs the processing system 206 to operate as described in herein in further detail in accordance with the method 400.

Although the computing system 500 as depicted in FIG. 7 includes one software module in the present example, it should be understood that one or more modules could provide the same operation, as shown in greater detail in FIGS. 1-2 and 4-5. Similarly, while description as provided herein refers to a computing system 200 and a processing system 506, it is to be recognized that implementations of such systems can be performed using one or more processors, which may be communicatively connected, and such implementations are considered to be within the scope of the description.

The processing system 506 can comprise a microprocessor and other circuitry that retrieves and executes software 502 from storage system 504. Processing system 506 can be implemented within a single processing device but can also be distributed across multiple processing devices or sub-systems that cooperate in existing program instructions. Examples of processing system 506 include general purpose central processing units, applications specific processors, and logic devices, as well as any other type of processing device, combinations of processing devices, or variations thereof.

The storage system 504 can comprise any storage media readable by processing system 506 and capable of storing software 502. The storage system 504 can include volatile and non-volatile, removable and non-removable media implemented in any method or technology for storage of information, such as computer readable instructions, data structures, program modules, or other data. Storage system 504 can be implemented as a single storage device but may also be implemented across multiple storage devices or sub-systems. Storage system 504 can further include additional elements, such a controller capable, of communicating with the processing system 506.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the store media can be a non-transitory storage media. In some implementations, at least a portion of the storage media may be transitory. It should be understood that in no case is the storage media a propagated signal.

User interface 510 can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 510.

As described in further detail herein, the computing system 500 receives audio data 520 in the form of assessments. The audio data 520 may be an audio recording or a conversation, which may exemplarily be between two speakers, although the audio recording may be any of a variety of other audio records, including multiple speakers, a single speaker, or an automated or recorded auditory message.

Embodiments of the system can further have communicative access to one or more of a variety of computer readable mediums for data storage. The access and use of data found in these computer readable media are used in carrying out embodiments of the method as disclosed herein.

Referring to the system 100 illustrated in FIG. 1, one or more Analysis Modules 110, 120 are provided in the system 100. Each Analysis Module 110, 120 is responsible for administering an assessment of any candidate capabilities in a unique manner utilizing a unique technique. Analysis Modules 110, 120 may be of the form of automated interview questions to the candidate including, but not limited to written, audio, video, or machine-interactive formats. Additionally, Analysis Modules 110, 120 may take the form of any other interactive assessment given by an interviewer to a candidate including but not limited to live two-way voice or video interviews.

Analysis Modules 110, 120 may be provided by the system 100 as well as third party assessment providers in the form of a Pluggable Module 130. A framework is provided to easily incorporate new assessments through by encapsulating the assessment in a Pluggable Module 130 as a means of extending the assessment capabilities of the system 100.

Still referring to FIG. 1, each Analysis Module 110, 120 reports one or more scores 140 for the assessment given. Scores 140 may be computed manually when a human reviews assessment results. Alternately, scores 140 may be automatically derived through machine evaluation of results. In an exemplar embodiment, manual scores 140 are expressed through variable Likert scoring scales. Manual scoring is not mutually exclusive to automatic scoring and multiple scoring results are permitted for each assessment given.

The Analysis Modules 110, 120 are also configurable. In the exemplar embodiment multiple languages are configurable for language proficiency analysis modules. For example, language proficiency Analysis Modules 110 may include Language IQ in US English and Language IQ in Mexican Spanish. The Analysis Modules 110 may be configured for any candidate capability the user wishes to analyze. Analysis Modules 110 with distinct configurations are treated as separate assessments and may be combined to screen one candidate for a given position.

Analysis Modules 110 that have similar modes of assessment can reuse system-provided scoring methods. For example, two scoring methods may be available for any Analysis Module 110 such as Manual Likert scoring and machine scored Audio Analytics for modules 110 that record audio responses. These two system scoring methods are then available in combination or separately. System scoring methods are used in addition to the native scoring method specific to a particular Analysis Module 110.

Referring now to FIG. 2, an embodiment of the system 100 includes a process control system to present assessments to candidates in a specified order 180 with modifications to the order 180 possible as a result of specified scoring events.

In this embodiment of the system 100, all candidates applying for a given position are given an identical sequence of assessments with no variance in configuration or order of presentation. In other embodiments conditional logic may be applied to the order 180 of presentation of assessments with variations in flow and content driven by scoring results.

The Controller 200 is responsible for initiating 210, 230, 250 Analysis Modules with specified configurations and gathering resulting scores 220, 240. Scoring may arrive upon completion of an assessment or asynchronously. An exemplar method of asynchronous scoring is manual rating of a candidate's performance that occurs at a time that is days after the completion of the assessment. Such asynchronous scoring does not block further assessments while scoring is pending. An alternate embodiment configures blocking on further processing while asynchronous scoring results are pending to allow for alternate assessments to be rendered based on the results of the score.

When the Controller 200 determines that a candidate has completed all assessments to a final module 190 and all scores are rendered, the Candidate Record is sent to the Combiner 150 (FIG. 1) for processing.

Referring back to FIG. 1, the Combiner 150 which takes in one or more scores 140 from one or more Analysis Modules 110, 120, 130 and forms an aggregate score (not shown) for a candidate relative to the population of candidates applying for the same Position. Candidate Optimizer predictive scores 170 allows a recruiter to sort candidates who are most likely to be accepted through the hiring process. The predictive score 170 is derived from combining the scores 140 from the analysis modules 110, 120, 130, and external feedback adapters 160. This will be discussed in greater detail below.

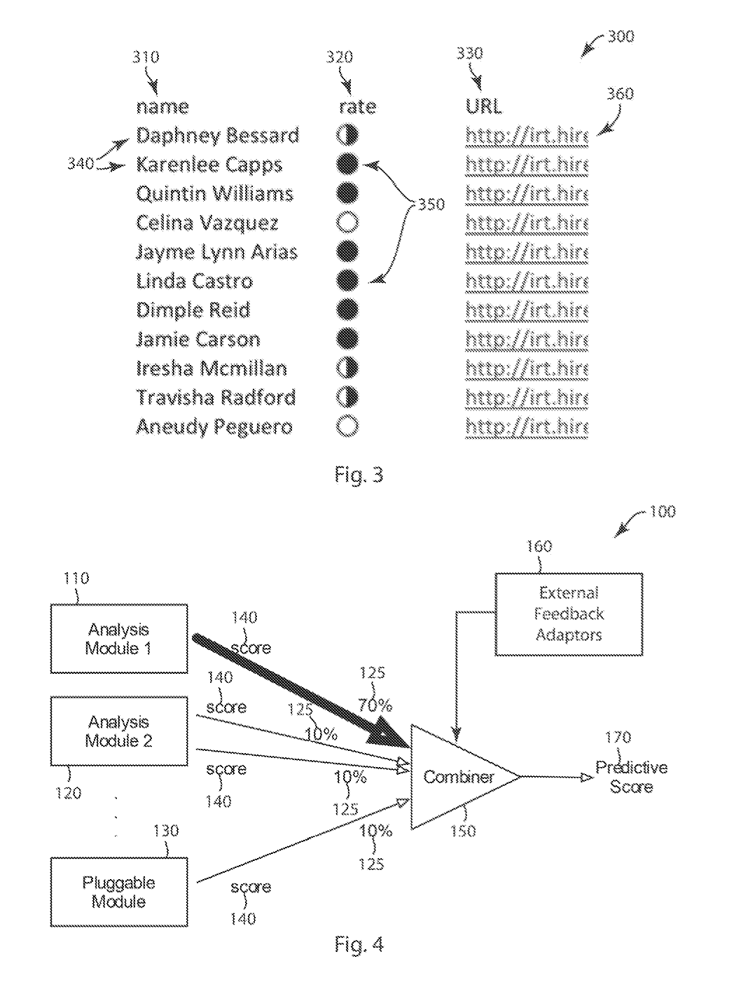

Referring now to FIG. 3, the graphical user interface (GUI) 300 illustrates to the user how candidates are rated in three bands relative to the general population's mean combined scores. The GUI 300 of FIG. 3 includes one embodiment of how the GUI 300 may be implemented. In this embodiment, a candidate column 310 includes candidate listings 340 for each of the candidates submitting an application. This GUI 300 also includes a rating column 320 which includes rating icons 350, and the URL column 330 includes URLs 360 for each of the candidates and the candidate listings 340. For example, candidate Daphney Bessard in the candidate listing 340 has a corresponding rating icon 350 of a half circle, and her resume may be viewed by selecting her URL 360. The rating bands are represented graphically in the embodiment as “Full Circle”, “Half Circle” and “Empty Circle” rating icons 350 as seen in FIG. 3. Additional embodiments allow for a variable number of scoring bands with alternate graphical rating icons 350. Additionally, filters for which type of bands and rating icons 35 are desired can be applied to the results GUI 30.

Analysis Module 110, 120, 130 scores 140 are normalized and used in a weighted average in the Combiner. Relative weights 125 are assigned to each score 140 emitted by an Analysis Module 110, 120, 130 used in the Position as depicted in FIG. 4. Default weightings are assigned by the system based on the default settings for the category of the position. Position Categories describe the types of attributes necessary to perform a certain job using standard terminology and assessments map into job attributes. Weightings assigned for each unique position in the system can override the defaults. In the embodiment illustrated in FIG. 1, the assessment administered by Analysis Module 1 (110) has the highest relative weight with a relative weight 125 of 70% versus the combined relative weight 125 of the rest of the Analysis Modules 120, 130.

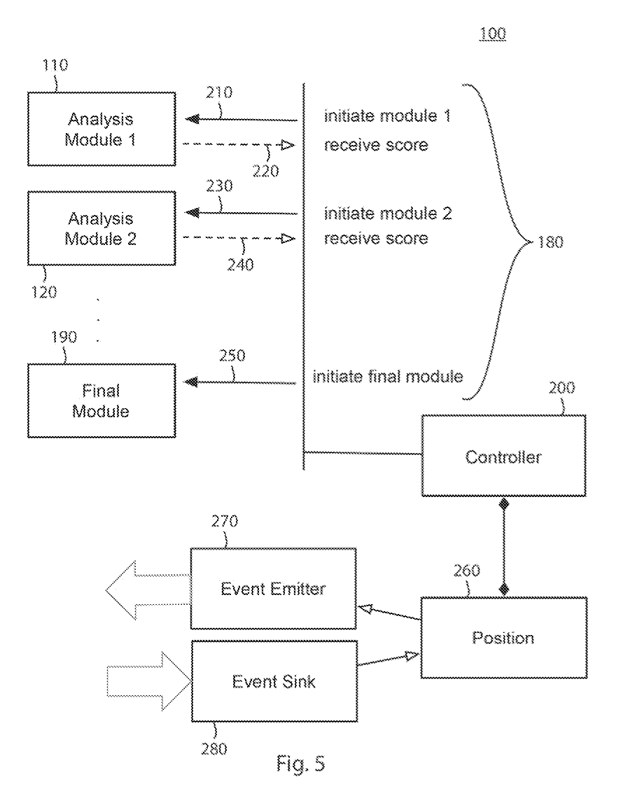

Referring now to FIG. 5, a position 260 is defined in the system to define the requirements of a class of recruited individuals. Positions 260 are labeled with required skills attributes upon creation. Each skill attribute maps into one or more specific Analysis Modules 110, 120, 190 that measure candidate proficiency in that area. Additional embodiments include providing intelligent defaults to the Combiner (150 (FIG. 1) based on analysis of similarly classified positions 260 screened by the system, taking advantage of the multi-tenant nature of the system.

Additional embodiments include providing a scheduling system to guarantee candidates and recruiters advance through the hiring process in a timely manner. Measurements for time tracking in the candidate workflow as well as the recruiter workflow are provided to improve time to process applicants.

Still referring to FIG. 5, software events are emitted and absorbed by the System 100 for reporting and coordination with 3^{rd} party systems such as Applicant Tracking Systems. Events from third party systems create positions, invite candidates to apply for those positions and provide employee status change events such as Hire and Terminate events such events enter the system through an event sink 280 and the position 260. Events emitted by the System 100 include state changes of the candidate lifecycle including, start of application, taking of Assessment Modules, scored results, automatic disqualification and completion of Assessment. Recruiter events are emitted as well including review and rating of candidate, advancing or declining the candidate and forwarding the candidate to other operators in the system 100. Such events leave the system 100 through the event emitter 270. In other words, the event sink 280 and event emitter 270 act as the non-assessment communication portal between the system 100 and third parties and third-party systems.

Referring now to the method 400 illustrated in the flow chart of FIG. 6, the system receives candidates applications into the system 100 in step 410 and applies multiple analysis technique to each candidate application as described herein in step 420. In step 420, the processor controller determines the order of the multiple analysis techniques and controls the operation of the applying step. A score for each analysis technique for each candidate is assigned in step 430 as described herein, and each of these scores may or may not be weighted as determined by the user. The scores for all of the analysis techniques are combined for each individual candidate with a set of feedback information in step 440. An aggregate score based on the combining steps is outputted in step 450 and may or ma not be graphically shown to the user.

Additional embodiments include the introduction of externally generated post-hire performance metrics (external feedback adapters 160) for candidates after they pass through the System 100 (FIG. 1). Post-hire metrics are used to optimize the weighting of Analysis Module 110, 120, 130 scores 140 in the Combiner 100 in order to maximize the statistical correlation between Predictive Score 170 and Post-Hire metrics. Standard curve fitting Machine Learning and signal processing techniques (e.g., hysteresis) are used.

Additional embodiments include providing optimized recruitment ordering for candidates passing through the prescribed assessments with drill down on individual criteria and sorting within a band on constituent assessment scoring. Arbitrary bands of candidates are provided so that recruitment of candidates can be optimized for a particular band. For example, some companies do not recruit the top 10% candidates, but want above average only.

While embodiments presented in the disclosure refer to assessments for screening applicants in the screening process additional embodiments are possible for other domains where assessments or evaluations are given for other purposes.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A computerized method, comprising:
receiving a plurality of candidate applications into a valuation system;
applying a plurality of analysis techniques to each of the plurality of candidate applications;
assigning a score for each of the plurality of analysis techniques corresponding to each of the plurality of candidate applications;
combining the scores of the plurality of analysis techniques for each of the plurality of candidate applications with a set of feedback information for each of the plurality of candidate applications; and
outputting an aggregate score based on the combining.

2. The method of claim 1, wherein a plurality of analysis modules applies the plurality of analysis techniques.

3. The method of claim 2, wherein any of the plurality of analysis modules is a third party pluggable module.

4. The method of claim 1, wherein the plurality of analysis techniques include any of the following:
a set of automated interview questions;
an interactive assessment administered by an interviewer; and
a third-party assessment method, wherein the plurality of analysis techniques are user configurable for any candidate capability.

5. The method of claim 1, wherein the assigned scores are derived through a manual scoring system.

6. The method of claim 1, wherein the assigned scores are derived through a machine evaluation system.

7. The method of claim 1, wherein a controller determines and effectuates an order of score reporting for each of the plurality of analysis techniques, and further initiates the application of each of the plurality of analysis techniques.

8. The method of claim 1, wherein the assigned scores of the plurality of analysis techniques are selectively weighted by the user.

9. The method of claim 1, wherein an applicant communicates with the controller through an event sink and an event emitter through a position module.

10. The method of claim 1, further comprising implementing the outputted aggregate score into a graphical user interface (GUI), wherein the GUI includes a plurality of score icons reflecting the aggregate score of each of the plurality of candidate applications.

11. A non-transitory computer-readable medium having computer executable instructions for performing a method, comprising:
receiving a plurality of candidate applications into a valuation system;
applying a plurality of analysis techniques to each of the plurality of candidate applications;
assigning a score for each of the plurality of analysis techniques corresponding to each of the plurality of candidate applications;
combining the scores of the plurality of analysis techniques for each of the plurality of candidate applications with a set of feedback information for each of the plurality of candidate applications; and
outputting an aggregate score based on the combining.

12. The method of claim 11, wherein a plurality of analysis modules applies the plurality of analysis techniques.

13. The method of claim 12, wherein any of the plurality of analysis modules is a third party pluggable module.

14. The method of claim 11, wherein the plurality of analysis techniques include any of the following:
a set of automated interview questions;
an interactive assessment administered by an interviewer; and
a third-party assessment method, wherein the plurality of analysis techniques are user configurable for any candidate capability.

15. The method of claim 11, wherein the assigned scores are derived through a manual scoring system.

16. The method of claim 11, wherein the assigned scores are derived through a machine evaluation system.

17. The method of claim 11, wherein a controller determines and effectuates all order of score reporting for each of the plurality of analysis techniques, and further initiates the application of each of the plurality of analysis techniques.

18. The method of claim 11, wherein the assigned scores of the plurality of analysis techniques are selectively weighted by the user.

19. The method of claim 11, wherein an applicant communicates with the controller through an event sink and an event emitter through a position module.

20. The method of claim 11, further comprising implementing the outputted aggregate score into a graphical user interface (GUI), wherein the GUI includes a plurality of score icons reflecting the aggregate score of each of the plurality of candidate applications.

21. In a computer system having a graphical user interface, a method of providing an aggregate score for each of a plurality of candidates for a position, the method comprising:
applying a plurality of analysis techniques to each of a plurality of candidate applications;
assigning a score for each of the plurality of analysis techniques and combining the scores to derive the aggregate score for each of the plurality of candidates;
displaying on the graphical user interface, a list of the plurality of candidates, a listing of a plurality of score icons corresponding to the list of the plurality of candidates, and a list of a plurality of URLs corresponding to the list of the plurality of candidates, where the list of the plurality of candidates provides additional information for each of the plurality of candidates.
